(19) United States
(12) Patent Application Publication
(10) Pub. No.: US 2008/0143473 A1
(43) Pub. Date: Jun. 19, 2008

(54) Digital Cross-Connect Path Selection Method

(76) Inventors: Kevin Wilson, Lake Forest, CA (US); Ninh Nguyen, Foothill Ranch, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/950,230

(22) Filed: Dec. 4, 2007

Related U.S. Application Data
(60) Provisional application No. 60/870,721, filed on Dec. 19, 2006.

(51) Int. Cl. H04Q 3/00

(52) U.S. Cl. 340/2.28

(57) ABSTRACT

Software is employed to create an array of switch identifiers based on a known switching system architecture. A switch identifier array is preferably determined and stored in the system as part of the system manufacturing process prior to deployment of the system at an end user site. A relatively straight forward indexing operation may then be used to determine those sets of switches which are available to establish a desired interconnection, greatly simplifying selection of appropriate switches to create a desired path during real time operation of a deployed system.

### RELATED APPLICATIONS

This application claims the Paris Convention priority of U.S. Provisional Application No. 60/870,721 entitled “Digital Cross-Connect Path Selection Method,” filed Dec. 19, 2006, the contents of which are hereby incorporated by reference in their entirety.

### FIELD OF INVENTION

The present invention relates in general to telecommunications switching systems and more particularly to an efficient and cost effective method for facilitating cross-connect path selection in such systems.

### BACKGROUND OF THE INVENTION

Digital cross-connect systems are an integral part of today's modern telecommunications transport network. They are increasingly used by all service providers including exchange carriers, long distance carriers, and competitive by-pass carriers. Significant technology advancements have allowed digital cross-connect systems to evolve from narrowband grooming and test applications to cross-connect of larger network signals in wideband and broadband frequency domains.

A broadband system is typically used to terminate high speed SONET optical and electrical signals in order to path terminate and groom lower speed broadband signals. The broadband system also supports performance monitoring and test access functions. Typical broadband cross-connect systems use either single stage or three stage Clos matrix architecture. In the three stage matrix architecture, the cross-connect includes switches grouped into an originating stage, a center stage, and a terminating stage. The three stage matrix architecture is best suited for maximum capacity applications for cross-connecting a large volume of signals. The single stage matrix architecture organizes the single stage matrices in rows and columns, which results in a higher number of switches than the three stage architecture.

### SUMMARY

As those skilled in the art will appreciate, a key task in a cross-connect system is to select the appropriate switches in the system to complete a desired cross-connect. One approach to accomplishing the switch selection and interconnection task just discussed would be to employ software to determine the appropriate group of switches in real time during operation of the switching array. This approach creates tremendous software overhead and complexity. According to the preferred embodiment, this approach is avoided by employing software to first create an array of switch identifiers based on the specific, known switching system architecture, which greatly simplifies selection of appropriate switches to create a desired path during real time operation of a deployed system. Thus, such a switch identifier array is preferably determined and stored in the system as part of the system manufacturing process prior to deployment of the system at an end user site. A relatively straight forward indexing operation may then be used to determine those sets of switches which are available to establish a desired interconnection.

### DESCRIPTION OF DRAWINGS

FIG. 1 is a schematic diagram of a switching array according to an illustrative embodiment.

FIG. 2 is a schematic diagram of an array of switch identifiers according to an illustrative embodiment.

FIG. 3 is a block diagram of a computer processor and associated memory according to an illustrative embodiment.

FIG. 4 is a flow diagram of a switch selection process employing the illustrative embodiment.

### DETAILED DESCRIPTION

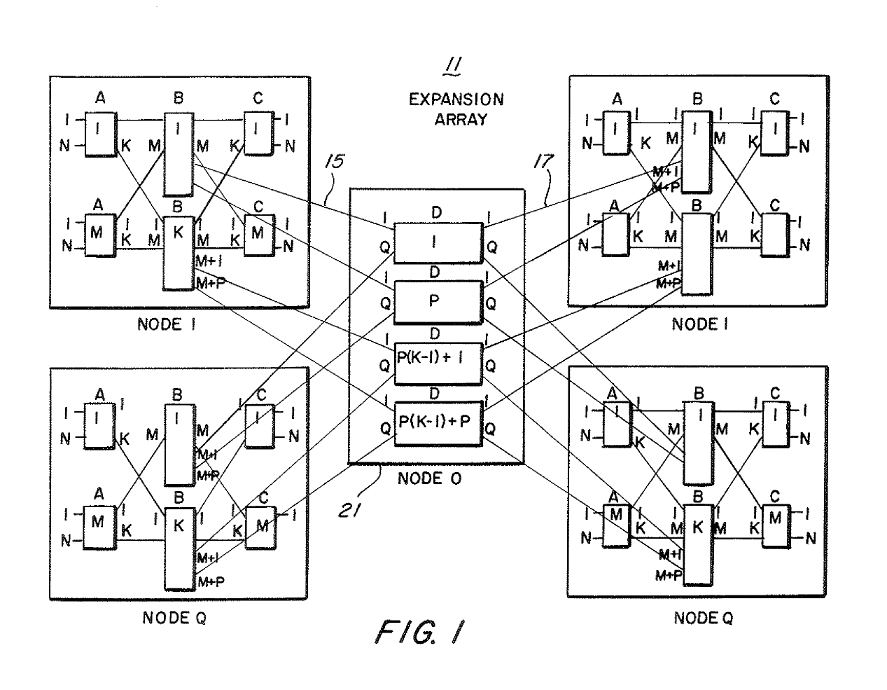

FIG. 1 illustrates a switching array network according to an illustrative embodiment. The invention may be applied to many other systems and in many other contexts, for example, including conventional three stage Clos matrix architectures. The system 11 of FIG. 1 comprises a plurality of Nodes 1 . . . Q and an Expansion Array 21, also identified as Node 0. In FIG. 1, each of the nodes e.g. Node 1, is drawn twice, once at the left of Expansion Array 21 and once to the right of the Array 21. This depiction is employed so that the interconnections, e.g. 15, 17, to the Expansion Array from the left and right side of the “B” arrays in each of the nodes do not overlap other portions of the drawing and are therefore more clearly shown.

Each of the nodes of FIG. 1 other than Node 0 (the Expansion Array) have a common three stage structure formed of A, B, and C switching arrays, interconnected as shown. The Expansion Array comprises a column of “D” switching arrays. The A, B, C and D arrays are defined as follows:

An array of type A has N inputs and K outputs.

An array of type B has M+P inputs and M+P outputs.

An array of type C has K inputs and N outputs.

An array of type D has Q inputs and Q outputs.

Further with respect to the topology of FIG. 1, it may be observed that Node 1 through Q has only arrays of type A, B and C, while Node 0 has only arrays of type D. As to the number of arrays, there are M arrays of type A in each of node 1 thru node Q, there are K arrays of type B in each of Node 1 thru Node Q, there are M arrays of type C in each of node 1 thru node Q, and there are R arrays of type D in Node 0 where R=K×P. The various arrays may be identified as follows:

A₍ₘ₎ denotes a type A array m in node q where m=1 . . . M; and q=1 . . . Q.

B₍ₖ₎ denotes a type B array k in node q where k=1 . . . K; and q=1 . . . Q.

C₍ₘ₎ denotes a type C array m in node q where m=1 . . . M; and q=1 . . . Q.

D₍ᵣ₎ denotes a type D array r in node 0 where r=P(k−1)+p; k=1 . . . K; p=1 . . . P.

The interconnection of the respective A, B, C and D arrays are defined as follows:
1. Output k of array A₍ₘ₎ in node q connects to input m of array B₍ₖ₎ in the same node q, where in m=1 . . . , M and k=1 . . . K.
2. Output m of array B₍ₖ₎ in node q connects to input k of array C₍ₘ₎ in the same node q, where m=1 . . . M and k=1 . . . K.
3. Output M+p, of array B₍ₖ₎ in Node q connects to input q of array D_{(r=P(k-1)+p)} in Node 0, where p=1 . . . P; k=1 . . . K; and q=1 . . . Q.
4. Output q of array D_{(r=P(k-1)+p)} in Node 0 connects to input M+p of array B₍ₖ₎ in Node q, where q=1 . . . Q; k=1 . . . K; and p=1 . . . P.
   Thus, it will be observed that outputs M+1 . . . M+p on each left Node B array and inputs M+1 . . . M+p on each right Node B array facilitate implementation of the Expansion Array's type D arrays.

In the switching array of FIG. 1, a switch is a device that may be activated to connect one input to one output of the same array. Each switch is represented by the notation S_{(node, array type, array number, input, output)}. For example, S_{(1,A,2,1,3)} denotes the switch that connects input 1 to output 3 of type A array 2 in node 1; S_{(0,D,3,2,5)} denotes the switch that bridges input 2 with output 5 of the type D array 3 in node 0.

Employing the switch notation convention just discussed, the switches of the A, B, C and D arrays are identified as follows:
1. The switch that connects input x to output k of the type A array m in node q is identified by S_{(q,A,m,x,k)}, where q=1 . . . Q; m=1 . . . M; x=1 . . . N; k=1 . . . K.
2. The switch that connects input m to output n of the type B array k in node q is identified by S_{(q,B,k,m,n)}, where q=1 . . . Q; k=1 . . . K; m=1 . . . M; n=1 . . . M.
3. The switch that connects input k to output y of the type C array m in node q is identified by S_{(q,C,m,k,y)}, where q=1 . . . Q; m=1 . . . M; k=1 . . . K; y=1 . . . N.
4. The switch that connects input p to output t of the type D array r in node 0 is identified by S_{(0,D,r,p,t)}, where r=1 . . . P(k−1)+p; p=1 . . . P; t=1 . . . P.
   Moreover, in the illustrative embodiment of FIG. 1 under discussion, an input of a type A array is also viewed as an input of the network. An output of a type C array is also viewed as an output of the network. The path (continuity) between one network input and one network output (one input of a type A array and one output of a type C array) can be established by serially connecting five switches (S1, S2, S3, S4 and S5) where S1 is a switch that connects an input and output of the 1^{st} array of type A; S2 is a switch that connects an input and output of the 2^{nd} array of type B; S3 is a switch that connects an input and output of the 3^{rd} array of type D; S4 is a switch that connects an input and output of the 4^{th} array of type B; and S5 is a switch that connects an input and output of the 5^{th} (last) array of type C.

As may be appreciated, more than one possible path (more than one set of switches (S1, S2, S3, S4, S5)) exists between any two I/O points in the network. In the illustrative embodiment, the following procedure is used to determine all possible paths (S1, S2, S3, S4, S5) between two I/O points in the network.

First, the following constants are defined:

Q=number of I/O nodes in the network

N=number of inputs on each type A array

N=also number of outputs on each type C array

K=number of outputs on each type A array

K=also number of inputs on each type C array

M=number of local inputs (from type A array) on each type B array

M=also number of local outputs (to type C array) on each type B array

P=number of foreign inputs (from type D array) on each type B array

P=number of foreign outputs (to type D array) on each type B array

Next, for a port (X=1 . . . (N×M×Q)), and for (k=1 . . . K), a series of values for variables q, m and n are defined as follows:

q=int(X/(N×M×Q))+1

m=int(X/(N×M×q))+1

n=X−int(X/(q×m×N))×N

In such case, then the set of all switches S1, S2, S3, 84, S5 available for interconnecting a selected port “X” with a selected port “Y” within the same Node is determined as follows for (t=1 . . . M) and for a port (Y=1 . . . N):

S1=S_{(q,A,m,n,k)} (Equation 1)

S2=S_{(q,B,k,m,t)} (Equation 2)

S3=S_{(0,D,0,0,0)} (Equation 3)

S4=S_{(q,B,k,m,t)} (Equation 4)

S5=S_{(q,C,t,k,Y)} (Equation 5)

and the set of switches S1, S2, S3, S4, S5 for connecting a port “X” in one Node with a port “Y” in a different Node is determined as follows for (t=1 . . . P), for (h=1 . . . K) and for a port (Y=1 . . . N):

S1=S_{(q,A,m,n,k)} (Equation 6)

S2=S_{(q,B,k,m,t)} (Equation 7)

S3=S_{(0,D,P(k-1)+t,q,w)} (Equation 8)

S4==S_{(w,B,k,t,h)} (Equation 9)

S5=S_{(w,C,h,k,Y)} (Equation 10)

As those skilled in the art will appreciate, a key task in a system such as that illustrated in FIG. 1 is to select the appropriate switches in the Nodes 1 . . . Q and the Expansion Array 21 to complete a desired cross-connect. For example, if it is desired to connect port “I” (“X” Port) of the A array in Node 1 to port “1” (“Y” Port) of the C array in Node 1, appropriate switches in Node 1 (and no switch in the Expansion Array 21) must be selected and closed to create the desired signal path. Thus, as noted above, a “path” may comprise a group or set of switches which serially interlink a desired pair of ports (“X” and “Y”) through the hardware system.

One approach to accomplishing the switch selection and interconnection task just discussed would be to employ software to determine the appropriate group of switches in real time during operation of the switching array of FIG. 1. This approach creates tremendous software overhead and complexity. According to the preferred embodiment, this approach is avoided by employing software to first create an array of switch identifiers based on the specific, known switching system architecture, which greatly simplifies selection of appropriate switches to create a desired path during real time operation of a deployed system. Thus, such a switch identifier array is preferably determined and stored in the system as part of the system manufacturing process prior to deployment of the system at an end user site. A relatively straight forward indexing operation may then be used to determine those switches which may be closed to achieve a desired interconnection.

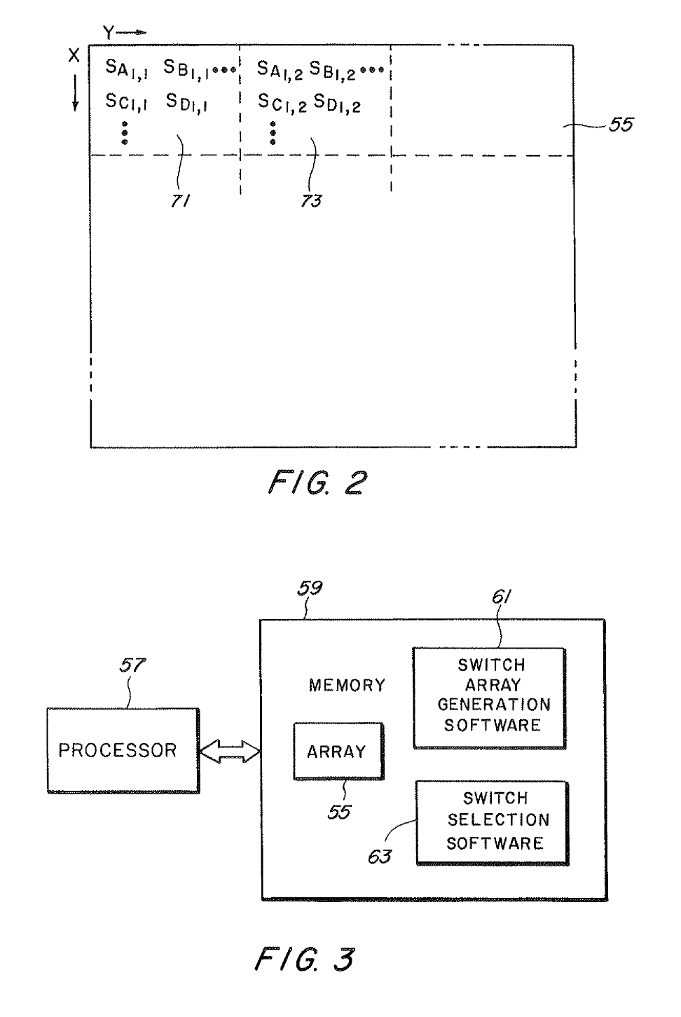

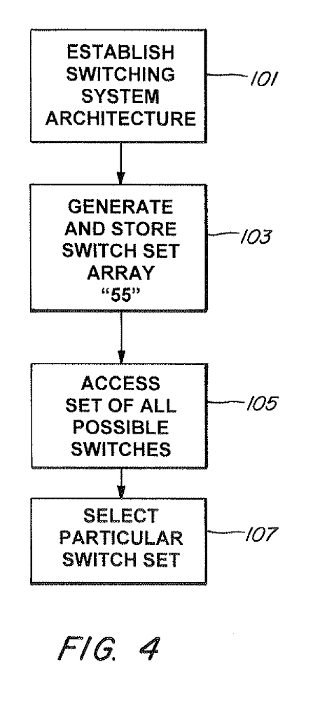

More particularly, in the illustrative embodiment depicted in FIGS. 2 and 3, and as shown in FIG. 4, after the switching system architecture is established (step 101), software 61 running on a computer processor 57 generates an array 55 of switch identifiers (step 103), and stores the array 55 in memory 59. As shown in FIG. 2, the array 55 is divided into sub-arrays, e.g. 71, 73. Each sub-array contains all sets of switches S1, S2, S3, S4, S5 which are capable of connecting a selected “X” Port to a selected “Y” Port. For example, all switch sets S_{A(1,1)} . . . S_{N(1,1)} for connecting “X” Port 1 to “Y” Port 1 are stored in sub-array 71, while all switch sets S_{A(1,2)} . . . S_{N(1,2)} for connecting “X” Port 1 with “Y” Port 2 are stored in sub-array 73, and so forth. Each sub-array is determined by software program steps of software 61, which may, for example, compute either equations 1-5 or equations 6-10 above for the particular port pair (X,Y,) in question. Such software may be written, for example, in C++, or any other suitable language.

Once the array of FIG. 2 has been generated, for example, prior to shipping and deployment of a switching array such as that shown in FIG. 1, the switch selection software 63, which actually selects a particular switch set (such as switch set S_{A1,1}) to establish connection between a pair of ports (such as ports 1,1), need only employ an index (e.g. “1,1”) during real time operation to access the set 71 of all possible switches for establishing a particular port-to-port connection (step 105, FIG. 4). Thereafter, in step 107 of FIG. 4, for example, the switch selection software may perform a particular switch selection procedure employing various criteria, such as those known to those skilled in the art, for selecting a particular pair of switches from those which are available.

Those skilled in the art will appreciate that various adaptations and modification is of the just described preferred embodiment can be configured without departing from the scope and spirit of the invention. Therefore, it is to be understood that, within the scope of the appended claims, the invention may be practiced other than as specifically described herein.

1. A computer implemented method for use in establishing interconnections in a cross-connect switching system having a plurality of ports comprising:
generating an array, said array comprising a plurality of sub-arrays, each sub-array containing all sets of switches which can be closed to achieve a cross-connection between a selected pair of ports of said system;
storing said array in memory such that it is available for a subsequent computer implemented switch selection process.

2. The method of claim 1 further including utilizing said array in the course of a computer implemented procedure for selecting a particular set of switches to achieve a desired connection between a selected pair of ports of said switching system.

3. The method of claim 1 wherein said array facilitates direct access to a plurality of sets of switches, each set containing all possible sets of switches for achieving interconnection of a selected pair of ports of said array.

4. The method of claim 1 wherein the set of all switches S1, S2, S3, S4, S5 available for interconnecting a selected port “X” with a selected port “Y” within the same Node is determined as follows for (I=1 . . . M) and for a port (Y=1 . . . N):
S1=S_{(q,A,m,n,k)} (Equation 1)
S2=S_{(q,B,k,m,t)} (Equation 2)
S3=S_{(0,D,0,0,0)} (Equation 3)
S4=S_{(q,B,k,m,t)} (Equation 4)
S5=S_{(q,C,t,k,Y)} (Equation 5)
and wherein the set of all such switches S1, S2, S3, S4, S5 for connecting a selected port “X” in one Node with a selected port “Y” in a different Node is determined as follows for (t=1 . . . P), for (h=1 . . . K) and for a port (Y−1 . . . N):
S1=S_{(q,A,m,n,k)} (Equation 6)
S2=S_{(q,B,k,m,t)} (Equation 7)
S3=S_{(0,D,P(k-1)+t,q,w)} (Equation 8)
S4==S_{(w,B,k,t,h)} (Equation 9)
S5=S_{(w,C,h,k,Y)} (Equation 10)
Wherein the variables M, N, Y, X, q, A, m, n, K, B, D, t, C are defined as set forth in the specification above.
